(19) United States
(12) Patent Application Publication
(10) Pub. No.: US 2015/0338239 A1
(43) Pub. Date: Nov. 26, 2015

(54) ABSOLUTE ENCODER

(71) Applicant: CANON KABUSHIKI KAISHA, Tokyo (JP)

(72) Inventor: Makiko Ogasawara, Utsunomiya-shi (JP)

(21) Appl. No.: 14/650,621

(22) PCT Filed: Feb. 26, 2014
(86) PCT No.: PCT/JP2014/001001

§ 371 Date: Jun. 9, 2015

(30) Foreign Application Priority Data
Feb. 27, 2013 (JP) 2013-037228

(51) Int. Cl. G01D 5/12; G01D 5/26

(52) U.S. Cl. CPC G01D 5/12; G01D 5/26

(57) ABSTRACT

Provided is an absolute encoder that includes a scale in which a plurality of marks including a plurality of types of marks is arrayed with a gap and a period; a detector including a plurality of elements and configured to detect marks of the plurality of marks with the plurality of elements; and a processor configured to: generate a data sequence by quantizing periodic signals with a plurality of periods obtained by the detector with respect to each of the plurality of periods, and generate a first position data based on the data sequence; generate a second position data corresponding to a phase of a signal obtained by decreasing values of the periodic signals with respect to both end portions thereof; and generate data representing the absolute position based on the first position data and the second position data.

### TECHNICAL FIELD

The present invention relates to an absolute encoder.

### BACKGROUND ART

Conventionally, an incremental encoder or an absolute encoder is used for measuring a position or a rotation angle of an object (the term “position” will be used as the general term or the superordinate concept for a position, a rotation angle, or the like). An incremental encoder executes optical or magnetic reading of the movement of a lattice during a fixed period that is provided on a scale, a disk, or the like, and uses origin point information to thereby measure the absolute position of the object. In recent years, resolution to the level of about 8 nanometers has been realized by miniaturization of a lattice pitch to about 80 microns, and further division of one pitch into approximately 10000 portions by an electrical dividing device to thereby interpolate the phase information. Furthermore, the effect of pattern errors in the lattice is reduced and a highly accurate measurement value can be obtained by optical reading of a plurality of lattice lines in parallel. However, the fact that absolute position information cannot be obtained in the absence of detection of an origin point has restricted applications, for example, to the field of machine tools or robotics.

On the other hand, an absolute encoder can measure an absolute position without detection of the origin point by using a light-receiving element array or an imaging element such as a CCD or the like to read a pattern on a scale corresponding to a gray code, an M sequence code, or the like. Patent Literature 1 discloses a configuration of an absolute scale that realizes an absolute code as a cyclic code configured using two values by applying a difference to the reflectance (transmittance) of the reflection (transmission) lattice between a non-reflection (transmission) lattice and a reflection (transmission) lattice on the incremental scale. This configuration uses a light-receiving element array to obtain data in the form of a light/dark periodic pattern obtained by projecting light onto the scale. An absolute code is obtained using information in relation to the amplitude of the waveform data, and phase information is obtained from the value obtained from the sum of products of the waveform data and the respective data for the plurality of standard waveforms. The sum of products calculation exhibits a tendency to generate errors when using the raw waveform data, and therefore the calculation is performed after the amplitude of the waveform data is normalized to obtain a periodic function.

### CITATION LIST

### Patent Literature

Patent Literature 1: Japanese Patent Application Laid-Open No.2012-37392

However, the method disclosed in Patent Literature 1 exhibits the disadvantage that time is required for processing to obtain the absolute position as a result of the division operations performed in order to normalize the amplitude of the waveform data.

### SUMMARY OF INVENTION

The present invention provides, for example, an absolute encoder advantageous in time required for processing which obtains an absolute position.

According to an aspect of the present invention, an absolute encoder includes a scale in which a plurality of marks including a plurality of types of marks is arrayed with a gap and a period; a detector including a plurality of elements and configured to detect marks of the plurality of marks with the plurality of elements; and a processor configured to obtain an absolute position of the scale or the detector based on an output of the detector, wherein the processor is configured to: generate a data sequence by quantizing periodic signals with a plurality of periods obtained by the detector with respect to each of the plurality of periods, and generate a first position data based on the data sequence; generate a second position data corresponding to a phase of a signal obtained by decreasing values of the periodic signals with respect to both end portions thereof; and generate data representing the absolute position based on the first position data and the second position data.

Further features of the present invention will become apparent from the following description of exemplary embodiments with reference to the attached drawings.

### BRIEF DESCRIPTION OF DRAWINGS

[FIG. 1]

FIG. 1 illustrates the overall configuration of the encoder according to the present invention.

[FIG. 2]

FIG. 2 illustrates a scale SCL according to the present invention.

[FIG. 3]

FIG. 3 illustrates an example of a periodic signal having a gradation modulation according to one embodiment of the present invention.

[FIG. 4]

FIG. 4A illustrates an example of a general window function.

[FIG. 4B]

FIG. 4B illustrates an example of the hatched portion according to one embodiment of the present invention.

[FIG. 5]

FIG. 5 illustrates the relationship between bit number and ratio according to one embodiment of the present invention.

[FIG. 6]

FIG. 6A illustrates an example of interpolation error according to one embodiment of the present invention.

[FIG. 6B]

FIG. 6B illustrates an example of interpolation error according to one embodiment of the present invention.

[FIG. 6C]

FIG. 6C illustrates an example of interpolation error according to one embodiment of the present invention.

[FIG. 7]

FIG. 7 illustrates the relationship between error and ratio according to one embodiment of the present invention.

[FIG. 8]

FIG. 8 illustrates the relationship between error/ratio and transmittance difference according to one embodiment of the present invention.

[FIG. 9A]

FIG. 9A illustrates an example of a transmission type scale according to one embodiment of the present invention.

[FIG. 9B]

FIG. 9B illustrates an example of a light amount distribution from the transmission type scale such as illustrated in FIG. 9A.

### DESCRIPTION OF EMBODIMENTS

Hereinafter, preferred embodiments of the present invention will now be described with reference to the accompanying drawings.

### First Embodiment

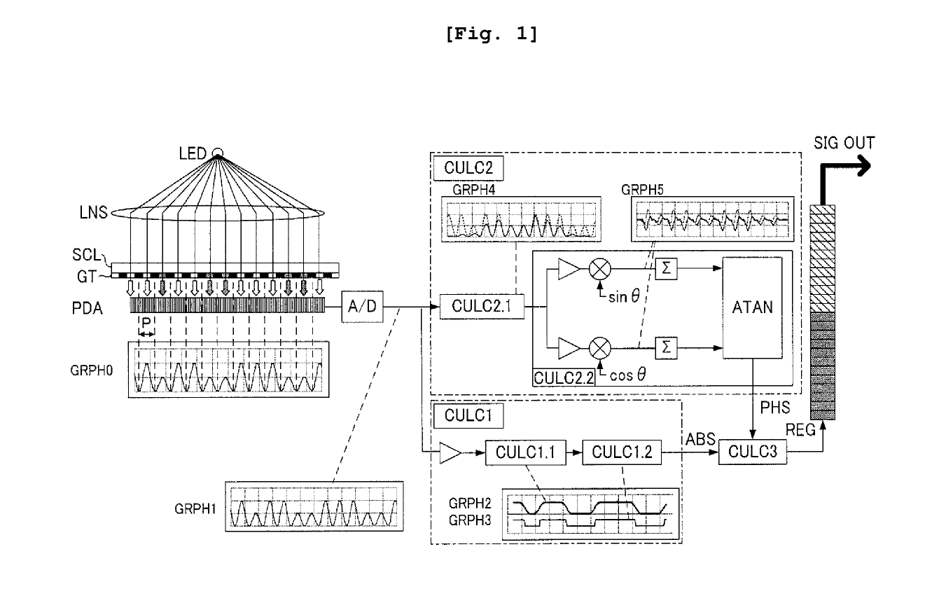

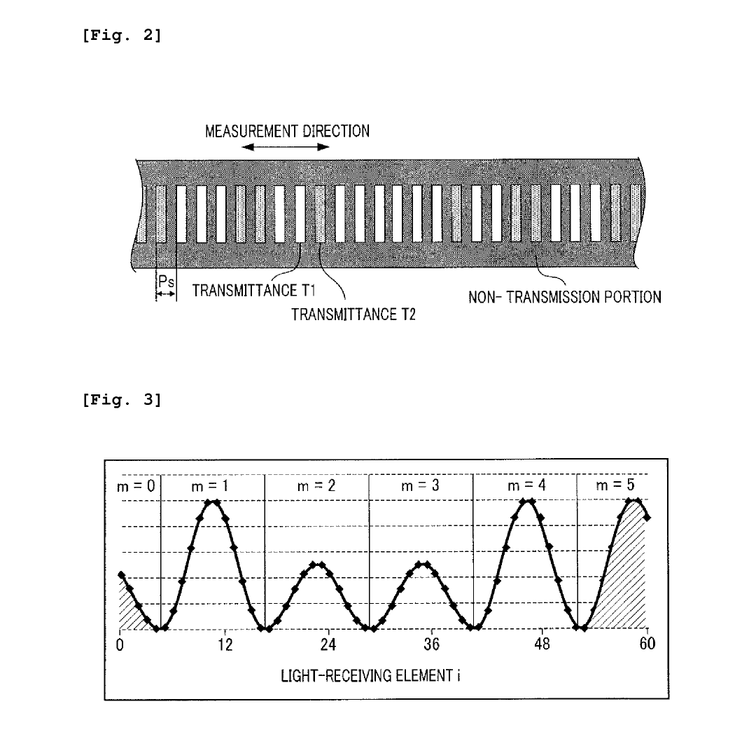

As illustrated in FIG. 1, a divergent light flux emitted from a point light source such as an LED is converted to parallel light by a collimator lens LNS. The parallel light is illuminated onto a scale SCL on which a plurality of marks is arrayed corresponding to an absolute code of M bits (code string representing absolute position). The scale SCL is configured to undergo rectilinear or rotational motion. When rotating, the scale can adopt the form of a disk. Alternatively, the scale may be fixed and configured to enable movement of the detector described below and the light source. The scale SCL includes a plurality of marks of at least two types of marks that are disposed in a fixed period or gap (first pitch) along one direction (first direction). The scale SCL as illustrated in FIG. 2 includes a slit GT having a slit with a transmittance T1 and a transmittance T2 disposed at a pitch Ps, and a non-transmission portion. The two types of slit having the transmittance T1 and the transmittance T2 configure two types of mark, and the two types of slit are arrayed in a plurality of arrays to represent an absolute code. The two types of mark have the same shape but exhibit a mutually different transmittance, and the two types of mark have respectively a uniform transmittance within the mark.

The light that passes through the mark that is formed from the slits having the transmittance T1 and the transmittance T2 of the scale SCL is received by a light-receiving element array (detector) PDA. The light-receiving element array PDA detects a string of a predetermined number of marks by use of a plurality of photoelectric conversion elements (elements) arrayed along the same direction as the array direction of the marks at a pitch that is smaller than the period of the mark. The light-receiving element array PDA is configured so that an N number of photoelectric conversion elements are disposed correspondingly to one mark, and the phase obtained by each photoelectric conversion element diverges at an equal interval. In the present embodiment, 12 photoelectric conversion elements correspond to one mark. The light/dark distribution of the incident light onto the light-receiving element array PDA is shown in GRPH0. The periodic signal waveform when a plurality of signals of the light-receiving element array PDA is temporarily held in the register REG and a clock signal is used as a trigger to execute serial transfer is illustrated in GRPH1 of FIG. 1. The waveform of GRPH1 is the same as GRPH0 that illustrates the light amount distribution of incident light onto the light-receiving element array PDA. In an analog signal state, the waveform illustrated in the figures is directly measured, and in a digital signal state after AD conversion, although a virtual waveform (digital data sequence) is configured from digital values, both waveforms are equivalent from a technical point of view. In the waveform GRPHO illustrated in FIG. 1, the amplitude of the sine wave waveform is modulated by the absolute code.

A calculation unit CULC calculates the absolute position in the first direction of the scale SCL relative to the light-receiving element array PDA based on the serial transfer waveform GRPH1 output by the light-receiving element array PDA. The serial transfer waveform GRPH1 is processed by a first calculation unit CULC1 and a second calculation unit CULC2 in the calculation unit CULC. The first calculation unit CULC1 generates a data sequence (first position data) configured by 12 pieces of data as a result of quantizing the respective amplitudes of 12 periodic signals (signal for 1 period) among periodic signals with a plurality of periods obtained by the light-receiving element array PDA. That is to say, the first calculation unit CULC1 firstly calculates a sum total signal for the output of a central photoelectric conversion element and a predetermined number of photoelectric conversion elements in that vicinity (for example, 5 adjacent elements), and converts the serial transfer waveform GRPH1 to the waveform such as GRPH2. The first calculation unit CULC1 furthermore obtains a digital signal waveform such as GRPH3 by quantizing (binarizing) the signal GRPH2 based on a comparison with a reference value (intermediate intensity). This waveform GRPH3 corresponds to a tentative absolute code (integer part of the absolute position). The tentative absolute code is configured into first position data with the mark period as an array unit (resolution).

The second calculation unit CULC2 multiplies the window function data described below by the serial transfer waveform GRPH1 from the light-receiving element array PDA in a first (calculation) operation unit CULC2.1. In this manner, the second calculation unit CULC2 generates a periodic signal as indicated by GRPH4. The second calculation unit CULC2 distributes the periodic signal generated by the first (calculation) operation unit CULC2.1 into two signals using the second (calculation) operation unit CULC2.2, and then performs the calculations described below to generate a waveform GRPH5. Thereafter, the second calculation unit CULC2 performs arctangent calculations ATN using the second (calculation) operation unit CULC2.2. In this manner, the second calculation unit CULC2 can obtain information (second position data or decimal part of absolute position) for a phase PHS that is equivalent to an incremental encoder periodic signal with an uniform amplitude. The data obtained from the second calculation unit CULC2 can be said to be data corresponding to a phase of a signal obtained by reducing the value of the periodic signal of the mark on both end portions that have not been detected over one period by the light-receiving element array PDA, among periodic signals. The detailed description of the second calculation unit CULC2 is given below.

A third calculation unit CULC3 generates data that represents the absolute position of the scale SCL based on the first position data obtained by the first calculation unit CULC1 and the second position data obtained by the second calculation unit CULC2. The third calculation unit CULC3 stores the generated data that represents the absolute position of the scale SCL as final code of the absolute encoder in a register REG. The data contained in the register REG is serially output in response to a request.

The detailed description of the second calculation unit CULC2 is given below. The second calculation unit CULC2 is divided into two blocks (processes) being a data pre-processor CULC2.1 (first (calculation) operation unit) and a phase information (calculation) operation unit CULC2.2 (second (calculation) operation unit) . When the phase of the i-th (1<=i<=60) standard waveform data S(i), C(i) used in the calculation is denoted as theta-p(i), the phase theta-s(i) of the i-th waveform data I(i) is used to express the phase information phi as shown by Equation 1 below.

θₛ(i)=θₚ(i)+Φ [Equation 1]

Where i is a data No.

FIG. 3 illustrates an example of waveform data I(i) that is obtained by the light-receiving element array. In this example, waveform data I(i) for light/dark 5 periods is obtained by the light-receiving element array that is configured to divide one light/dark period into 12 divisions. In this case, the waveform data I(i) is defined as shown in Equation 2 below.

$$I ( i ) = {T}_{m} * \frac{1}{2} \{ 1 - cos ( {θ}_{p} ( i ) + φ ) \} \qquad [ Equation 2 ]$$

Where Tm is a transmittance of m-th mark according to waveform data I(i) and M=0, 1, 2, 3, 4, 5.

Here, m denotes the identifying number of the mark (of the waveform) according to the waveform data I(i), and is applied as a number from left to right. Tm denotes the transmittance of the m-th mark. The identifying number of the leftmost mark (in FIG. 3, the mark in relation to which data for one period cannot be obtained) is taken to be m=0. In the example shown in FIG. 3, the transmittance Tm is as shown in Table 1.

TABLE 1

Identifying Number (m)

| | 0 | 1 | 2 | 3 | 4 | 5 |
|---|---|---|---|---|---|---|
| Transmittance Tm | T/2 | T | T/2 | T/2 | T | T |

Next, two data sets being sine wave-like reference waveform data (first and second waveform data) S (sine wave data) and C (cosine wave data) will be defined with reference to Equation 3 below.

S(i)=sin θₚ(i)

C(i)=−cos θₚ(i)

1≦i≦60 [Equation 3]

A sum of products calculation is performed respectively in relation to the waveform data I(i) and the reference waveform S (i), C(i) obtained from the light-receiving element to thereby obtain A (first phase signal) and B (second phase signal) as shown by Equation 4 below.

$$A = {\sum }_{i = 1}^{60} I ( i ) * S ( i ) = {\sum }_{m = 1}^{5} {T}_{m} * \frac{π}{2} sin ( φ ) + ( \frac{{T}_{0}}{4} - \frac{{T}_{5}}{4} ) \{ - 2 + 2 cos ( φ ) + φ sin ( φ ) \} \\ B = {\sum }_{i = 1}^{60} I ( i ) * C ( i ) = {\sum }_{m = 1}^{5} {T}_{m} * \frac{π}{2} cos ( φ ) + ( \frac{{T}_{0}}{4} - \frac{{T}_{5}}{4} ) ( φ cos ( φ ) - sin ( φ ) ) \qquad [ Equation 4 ]$$

Next, an arctangent calculation is performed using A, B from Equation 4 to thereby obtain the phase information phi′.

$${φ}^{′} = {tan}^{- 1} ( \frac{A}{B} ) \qquad [ Equation 5 ]$$

The second term in both A and B of Equation 4 is a term that may take a value of non-zero if the left end of the waveform data I(i) with 5 periods does not take a value of zero.

The second term takes a value of zero when the transmittance T0=T5, or the to-be-calculated phase information phi=0. In this case, the phase information phi′=the phase information phi. However, when the transmittance T0 is not equal to T5, and the to-be-calculated phase information phi is not equal to 0, the second term in both A and B of Equation 4 does not take a value of zero, and when the calculation in Equation 5 is performed, phase information phi′ is not equal to phase information phi. Here, the difference between the phase information phi′ and the phase information phi is defined as an error Ea, and the maximum value of the error Ea (when 0<=phi<2pi) is defined as the interpolation error Ed.

Thus, when the second term in Equation 4 is not zero, an interpolation error Ed is generated. Therefore, the present invention reduces the error in the calculated phase information phi by reducing the contribution of the two second terms in Equation 4 by use of window function data W(i) as shown below. That is to say, in substitution for Equation 4, Equation 6 below that expresses A′ (first data) and B′ (second data) is used.

$${A}^{′} = {\sum }_{i = 1}^{60} I ( i ) * S ( i ) * W ( i ) \\ {B}^{′} = {\sum }_{i = 1}^{60} I ( i ) * C ( i ) * W ( i ) \qquad [ Equation 6 ]$$

The detailed description of the window function data applied in Equation 6 will be given below.

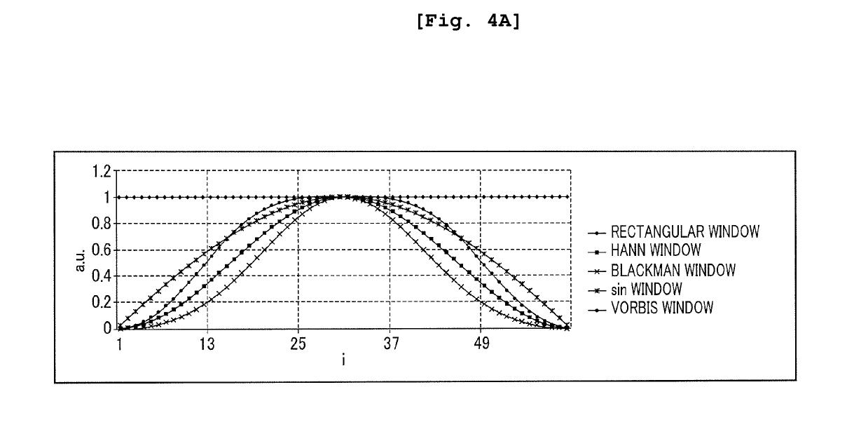

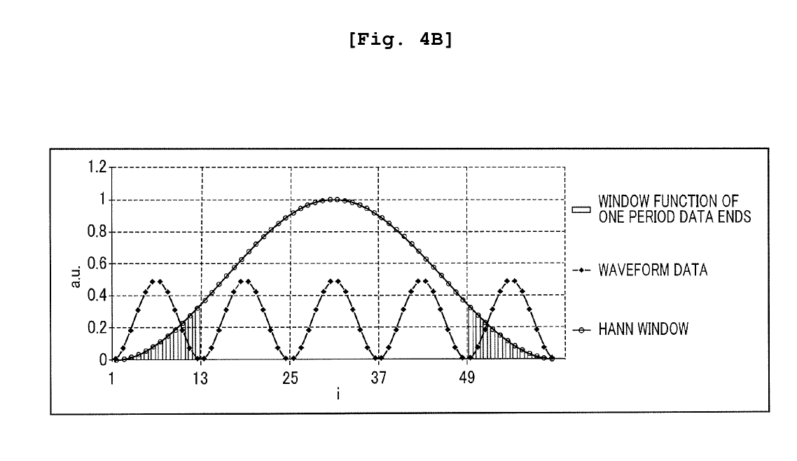

FIG. 4A illustrates an example of window function data. FIG. 4B illustrates a hann window function and a region (hatched portion) corresponding to a one period respectively from the two data ends i=1 and i=60 of the waveform data I (i) in the hann window function. The ratio R of the area occupied by the region in the overall window function data is given by Equation 7 below.

$$R = ( {\sum }_{i = 1}^{12} W ( i ) + {\sum }_{i = 49}^{60} W ( i ) ) / {\sum }_{i = 49}^{60} W ( i ) \qquad [ Equation 7 ]$$

Equation 7 is generally rewritten to given Equation 8.

$$R = ( {\sum }_{i = 1}^{n} W ( i ) + {\sum }_{i = ( M - 1 ) \times n + 1}^{M \times n} W ( i ) ) / {\sum }_{i = 1}^{M \times n} W ( i ) \qquad [ Equation 8 ]$$

In the formula, n denotes the light-receiving element number per one light/dark period, and M denotes the light/dark period number used in the phase calculation. Here, the region of the waveform data I(i) which contributes to the second term in Equation 4 not having a value of zero is always entered into one period from the respective two data ends of i=1 and i=M*n. Consequently, the ratio R of this region relative to the overall region may be used to approximate the ratio of the second term relative to the first term in Equation 4. Thus, a region of one period can be taken into account from the respective two data ends of i=1 and i=M*n. When the ratio R becomes smaller, the interpolation error Ed is reduced, and therefore the window function data W acts as a profile in which the ratio R is becoming smaller. The ratio R may become smaller by reason of an increase in the light-dark period number M (bit number of the absolute code) that is used in the phase calculation. FIG. 5 illustrates the relationship between M and the ratio R in Equation 8. As the value of M increases, the ratio R decreases. Furthermore, in comparison to a rectangular window that corresponds to the configuration in which the window function is not applied, other window functions enable the ratio R to be reduced in relation to the same M value.

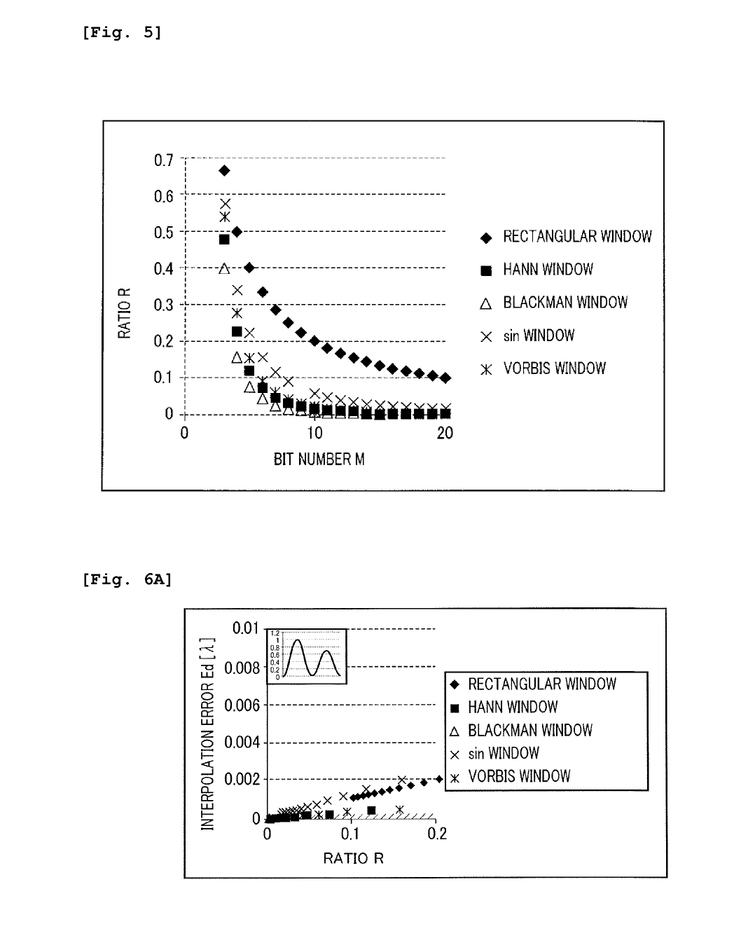

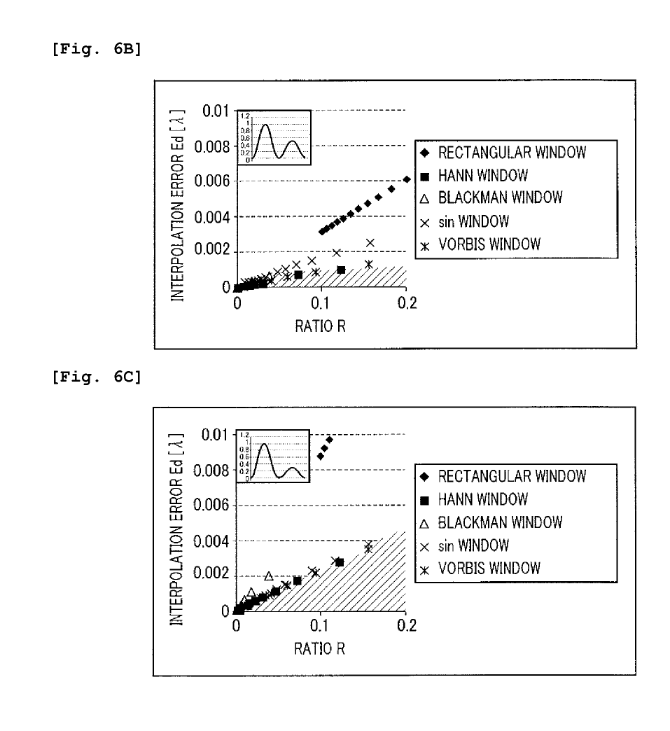

Next, FIG. 6 illustrates the correlation between the ratio R and the interpolation error Ed. The difference between the transmittance of the two types of mark is defined as transmittance difference delta-T. The interpolation error Ed expresses the ratio of the scale relative to the light/dark pattern period lambda. The code used herein is a code in which the value at one data end is 1 and the value at the other data end is zero. As clearly shown in Equation 4, the interpolation error Ed of this code is a maximum. FIG. 6A illustrates the correlation of the transmittance difference delta-T=0.3 [a.u.], FIG. 6B illustrates the correlation of the transmittance difference delta-T=0.5 [a.u.], and FIG. 6C illustrates the correlation of the transmittance difference delta-T=0.7 [a.u.]. FIG. 6A to FIG. 6C illustrates that as the ratio R of the respective window function data becomes smaller, the interpolation error Ed gradually decreases. Furthermore, in comparison to a result at the respective transmittance differences delta-T, as the transmittance difference delta-T becomes smaller, the interpolation error Ed also decreases. This feature coincides with the fact that there is a decrease in the transmittance difference which is a coefficient of the second term of both A and B in Equation 4. Furthermore, in FIG. 6A to FIG. 6C, the region which an optimal solution is not obtained for window function data relative to the interpolation error Ed is shown as a hatched portion.

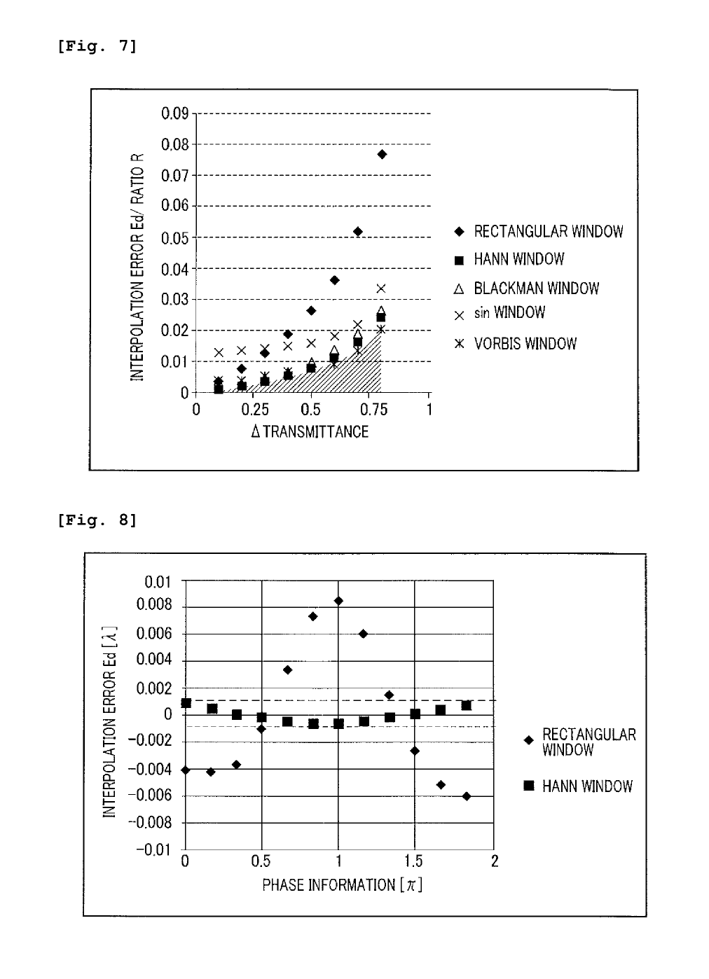

FIG. 7 illustrates the correlation between the transmittance difference delta-T and the slope of the interpolation error Ed relative to the ratio R. The minimum value of the slope on each transmittance difference delta-T is the boundary value of the region that includes the optimal solution. In FIG. 7, the hatched portion illustrates the region which an optimal solution is not obtained for window function data. As discussed above, the window function that includes the profile in which the ratio R is a region other than the hatched portion in FIG. 7 can be selected as the window function data W shown in Equation 6. The specific conditions are shown in Equation 9 below.

$$R < \frac{E}{0.001 {e}^{3.5 Δ T}} \qquad [ Equation 9 ]$$

Where E is an Allowable Error [lambda].

Here, Equation 9 illustrates a portion, other than the hatched portion in FIG. 7, that enables changing of the coefficient (value) of the window function within a scope in which the formula is satisfied.

A selection example of the window function data W will be described below. If it is assumed that the transmittance difference delta-T=0.5 and the tolerance (interpolation accuracy) is 0.001 lambda, then window function data W may be applied in which the ratio R is smaller than 0.17. The hann window function that satisfies this condition is applied as the window function data. FIG. 8 illustrates a comparison of the interpolation error Ed in the present embodiment, in relation to the calculation of A,B in Equation 4 in the range of 0<=phi<2pi, and in relation to the calculation of A′,B′ using the hann window function as window function data W in Equation 6. In FIG. 8, the broken line illustrates an tolerance of 0.001 lambda, and when applying the hann window function, this reaches an error of less than or equal to 0.001 lambda, and illustrates that the error is reduced to approximately 1/10 in comparison to a configuration in which a window function is not used.

In the same manner, selection as window function data W of a window function in which the ratio R satisfies Equation 9, such as a Blackman window function, a sin window function, a Vorbis window function, or the like enables the error during measurement to fall within a tolerance.

### Second Embodiment

Next, a second embodiment will be described below. Since the configuration of the apparatus, and the conditions for the window function data W are the same as those described in the first embodiment, description will not be repeated.

In the first embodiment, although a method for calculation by use of Equation 3 and Equation 6 was described, the second embodiment is configured to retain Equation 10 below as a standard waveform in advance.

S′(i)=S×W(i)=sin θₚ(i)×W(i)

C′(I)=C×W(i)=cos θₚ(i)×W(i)

1≦i≦60 [Equation 10]

The region required for memory can be reduced by retaining data obtained by multiplying the standard waveform data S, C with the window function data W. Furthermore, there is the advantage of a further shortening in the processing time.

### Other Embodiments

The present invention can be applied to various configurations as described below.

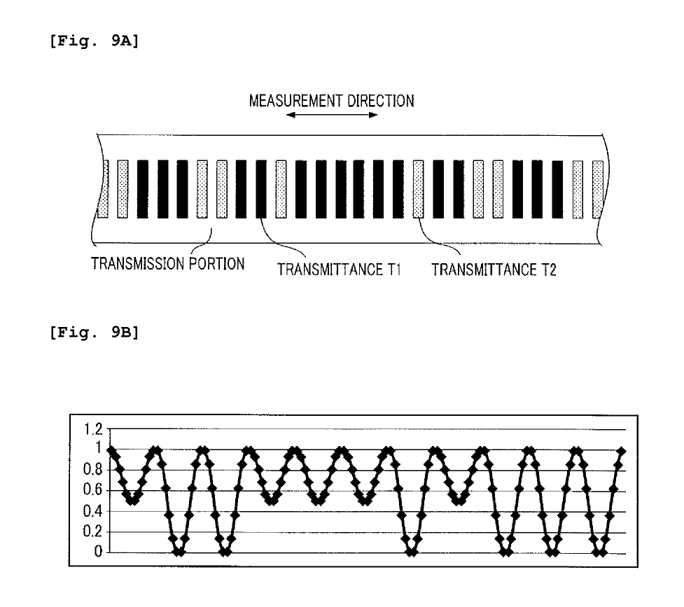

Application is possible to an encoder provided with a scale in which a transmissive grating(s) is disposed at an equal interval as illustrated in FIG. 9A. The light amount distribution is configured as illustrated in FIG. 9B as a vertical inversion on the light amount distribution from the scale illustrated FIG. 2, and the modulation amount of the light amount from the scale takes the minimum value at the transmission portion (portion in which the light amount is the maximum value).

Application is also possible to a reflection type scale encoder. In this case, the reference lattice on the scale is taken to be the non-reflective portion or the totally reflective portion, and a lattice (mark) having a reflectance of R1 or a lattice (mark) having a reflectance of R2 is inserted therebetween to thereby realize an absolute code.

The present invention can also be applied to an encoder provided with a scale having a gradation of at least three values (3 gradations) that can be discriminated rather than only two values (two gradations).

Fluctuation of the interval between the scale and the light-receiving element may distort a light projection pattern on the light-receiving element array. It is known that a generally a three-times harmonic component is generated in a light projection pattern under these conditions. However, the presence or the absence of the three-times harmonic component has no effect on the calculation performed using Equation 4. This feature is understood from the fact that the calculation result in Equation 11 below is zero.

$$A = {\sum }_{i = 1}^{12} \frac{1}{2} \{ 1 - cos ( 3 {θ}_{p} ( i ) + φ ) \} * S ( i ) = 0 \qquad [ Equation 11 ]$$

Therefore, the configuration according to the present embodiment enables an effective reduction in the effect of harmonic components, and thereby enables highly accurate calculation of the phase. The element number of the light-receiving element array PDA to detect one light/dark period may be varied in consideration of the availability of the light-receiving element array or of the required accuracy.

In consideration of the light amount non-uniformity caused by the optical system or the sensitivity dispersion of the elements in the light-receiving element array, at least one of the value and the formula used in the calculation in the present embodiment may be varied. Application is also possible of an approximate value depending on the required accuracy.

The signal processor in FIG. 1 may realize the same functions by use of another configuration, an algorithm, or a flow. For example, it may be realized by an arrangement in which a signal from the light-receiving element array is subjected to arithmetic processing (processing of addition, subtraction, multiplication and division) using parallel analog circuits, or an arrangement in which arithmetic processing or filtering processing is performed using serial analog circuits. Furthermore, an arrangement is possible in which calculation processing is performed on a digital signal obtained by AD conversion of the signal from the light-receiving element array using an integrated circuit such as FPGA or ASIC, or the like.

In addition, in the present embodiment, an optical system is used to detect a scale by use of a equal magnification resulting from the incidence of parallel light on the scale. However, another optical system may be applied such as an optical system configured to detect the scale by incidence and expansion of scattered light on the scale or an optical system configured to detect light from the scale through an image-formation optical system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-037228 filed Feb. 27, 2013, which is hereby incorporated by reference herein in its entirety.

1. An absolute encoder comprising:
a scale in which a plurality of marks including a plurality of types of marks is arrayed with a gap and a period;
a detector including a plurality of elements and configured to detect marks of the plurality of marks with the plurality of elements; and
a processor configured to obtain an absolute position of the scale or the detector based on an output of the detector,
wherein the processor is configured to:
generate a data sequence by quantizing periodic signals with a plurality of periods obtained by the detector with respect to each of the plurality of periods, and generate a first position data based on the data sequence;
generate a second position data corresponding to a phase of a signal obtained by decreasing values of the periodic signals with respect to both end portions thereof; and
generate data representing the absolute position based on the first position data and the second position data.

2. The absolute encoder according to claim 1, wherein the processor is configured to execute the decreasing based on a window function.

3. The absolute encoder according to claim 2, wherein the processor is configured to execute the decreasing based on at least one of window functions including a hann window function, a Blackman window function, a sine window function, and a Vorbis window function.

4. The absolute encoder according to claim 1, wherein the processor is configured to generate the second position data based on a ratio between a value obtained by a sum of products of a sine wave data having the period and a signal obtained by the decreasing, and a value obtained by a sum of products of a cosine wave data having the period and the signal obtained by the decreasing.

5. The absolute encoder according to claim 1, wherein the processor is configured to generate the second position data based on a ratio between a value obtained by a sum of products of a first data obtained by reducing portions corresponding to the both end portions of a sine wave data having the period and the periodic signals, and a value obtained by a sum of products of a second data obtained by reducing portions corresponding to the both end portions of a cosine wave data having the period and the periodic signals.

6. The absolute encoder according to claim 1, wherein the processor is configured to execute the decreasing so that an error of the second position data falls within a tolerance.
